(19) United States
(12) Patent Application Publication
(10) Pub. No.: US 2007/0221706 A1
(43) Pub. Date: Sep. 27, 2007

(54) METHODS FOR MAKING ALUMINUM CLAD COPPER WIRE

(75) Inventor: Robert N. Calliham, Newton, NC (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: COMMSCOPE, INC. OF NORTH CAROLINA, Hickory, NC (US)

(21) Appl. No.: 11/689,109

(22) Filed: Mar. 21, 2007

Related U.S. Application Data
(60) Provisional application No. 60/743,656, filed on Mar. 22, 2006.

(51) Int. Cl. A47J 36/02

(52) U.S. Cl. 228/101

(57) ABSTRACT

A method for making an aluminum clad copper wire from a copper wire and at least one aluminum strip solid phase bonded together may include treating a surface of the copper wire by heating the copper wire during exposure to an oxidizing ambient followed by a reducing ambient as the copper wire is advanced along a first input path. Similarly, the method may include treating a surface of the at least one aluminum strip by heating during exposure to an oxidizing ambient followed by a reducing ambient as the at least one second aluminum strip is advanced along at least one second input path. Further, the method may include roll forming and compressing together the treated surface of the copper wire and the treated surface of the at least one aluminum strip at a convergence between the first and at least one second input paths to make the aluminum clad copper wire and as the aluminum clad copper wire is advanced along an output path to thereby solid phase bond together the copper wire and the at least one aluminum strip. The aluminum clad copper wire may be cooled by passage through at least one quenching media bath as the aluminum clad copper wire is advanced along the output path.

### RELATED APPLICATION

This application is based upon and claims priority to copending provisional application No. 60/743,656 filed Mar. 22, 2006. The entire subject matter of this provisional application is incorporated herein by reference in its entirety.

### FIELD OF THE INVENTION

The invention relates to the field of electrical conductors, and, more particularly, to methodS for making an electrical conductor comprising an aluminum clad copper wire.

### BACKGROUND OF THE INVENTION

Bimetallic wires may be created by bonding two different metals into a single conductor. The result is a low-cost, light-weight alternative to using solid copper, for example. The BiMetals Division of CommScope Inc. manufactures in its Statesville, N.C. facility Copper Clad Aluminum (CCA) and Copper Clad Steel (CCS). Bimetallic wire applications include aerospace, automotive harness, battery cables, RF shielding, telecommunications, electronics, utilities and other industrial applications, for example. The BiMetals Division provides conductors made from bonding a coating of pure copper over another metal core. CommScope's coaxial cable products use both Copper Clad Aluminum and Copper Clad Steel conductors.

For example, two strips of Oxygen Free Copper, C10100, may be bonded to either a core of aluminum or a core of steel in a process known as solid cladding. The basic method of manufacturing is disclosed by in U.S. Pat. No. 3,714,701 assigned to Polymetallurgical Corp. Further developments are disclosed by U.S. Pat. No. 4,227,061 assigned to Copperweld Corp. The entire disclosure of each patent is incorporated herein by reference.

The basic approach is to provide heat into each of the materials and roll form the materials into a round section having an area approximately 10% smaller. The combination of heat and rolled reduction develop the bond. This metallurgically developed bond has the unique characteristic of being cold worked into small wires and retains the original ratio of metals.

A paper from 1989 presented by W. J. Leonhardt, AGS Dept, Brookhaven National Laboratory, at the 1989 IEEE meeting, and entitled “A Radiation Hard Dipole Magnet Coils Using Aluminum Clad Copper Conductors” and available at “http://epaper.kek.jp/p/89/pdf/pac1989_{—}0366.pdf” discloses an aluminum clad copper conductor. More particularly, an anodized hard non-conductive coating protects the magnet windings in a high gamma radiation environment. Traditional organic enamels and other coating had short life cycles in this environment. The cladding method uses a fixed length aluminum tube with the prepared copper conductor inserted into the tube. The second step is to draw or swage the aluminum tube around the copper conductor. The third step is to heat treat and anneal the aluminum which also sinters the two metals into a clad unit. This process may be laborious, time consuming, and could only produce fixed lengths up to 10 meters. This article further discloses that aluminum clad cable was used in the cable TV business and the cable was made by sandwiching a round copper conductor between two thin sheets of aluminum and then passing it all through a set of rollers which have a circular groove in their surface. The aluminum is bonded to the copper by the extreme pressure from the rollers and excess aluminum is slit off.

U.S. Pat. No. 2,947,069 discloses an aluminum clad copper wire having an enamel insulating layer thereover. The process for making the wire includes providing a silver coating on a copper rod and then a cold working operation applies the aluminum sleeve over the silver coated copper rod. U.S. Pat. No. 4,270,373 discloses forming an aluminum clad copper wire using a lubricant at the drawing die.

U.S. Pat. No. 5,091,609 discloses an insulated wire to be used in an automobile, for example, which is heated to a high temperature by the vehicle engine. The wire may have a copper core and an aluminum layer on the copper core. The aluminum layer has an oxide formed thereon to serve as the insulation layer by a sol-gel process or an organic acid salt pyrolytic process.

### SUMMARY OF THE INVENTION

In view of the foregoing background, it is therefore an object of the invention to provide a manufacturing process for efficiently and effectively making an aluminum clad copper wire.

This and other objects features and advantages in accordance with the invention are provided by a method for making an aluminum clad copper wire from a copper wire and at least one aluminum strip solid phase bonded together. The method may include treating a surface of the copper wire by heating the copper wire during exposure to an oxidizing ambient followed by a reducing ambient as the copper wire is advanced along a first input path. Similarly, the method may include treating a surface of the at least one aluminum strip by heating during exposure to an oxidizing ambient followed by a reducing ambient as the at least one second aluminum strip is advanced along at least one second input path. In addition, the method may include roll forming and compressing together the treated surface of the copper wire and the treated surface of the at least one aluminum strip at a convergence between the first and second input paths to make the aluminum clad copper wire. This roll forming and compression may be performed as the aluminum clad copper wire is advanced along an output path to thereby solid phase bond together the copper wire and the at least one aluminum strip. The method may further include cooling the aluminum clad copper wire by passage through at least one quenching media bath as the aluminum clad copper wire is advanced along the output path. Accordingly, a high quality aluminum clad copper wire may be efficiently produced.

The roll forming and compressing together the treated surface of the copper wire and the treated surface of the at least one aluminum strip may comprise applying a pressure in a range of about 4,000 to 20,000 psi. This may result in reducing a cross-sectional area of the aluminum clad copper wire from 8 to 20 percent, for example.

The method may further include passing the copper wire through an electrolytic acid bath as the copper wire is advanced along the first input path. The electrolytic acid bath may comprise cells of alternating polarity, and wherein a first cell has a same polarity as a last cell. The electrolytic acid bath may be at a temperature in a range of about 80 to 180° F. and may comprise an aqueous solution of about 5 to 30 percent by weight of sulfuric acid, for example.

Heating the copper wire may comprise heating the copper wire to a temperature in a range of 350 to 650° F. Similarly, heating the at least one aluminum strip may comprise heating the at least one aluminum strip to a temperature in a range of 300 to 725° F.

The copper wire may comprise an oxygen free copper wire having a circular cross section and a diameter in a range of 0.2 to 0.4 inches. In addition, the at least one aluminum strip may have a thickness in a range of 0.003 to 0.030 inches. Typically two such aluminum strips are solid phase bonded to the copper wire.

The oxidizing ambient for the copper wire and/or the at least one aluminum strip may comprise air. The reducing ambient may comprise 2 to 100 percent by weight of hydrogen in an inert gas, also as an example.

The method may further comprise exposing the aluminum clad copper wire to air or inert gas for a predetermined length of the output path prior to the at least one quenching media bath. In addition, the at least one quenching media bath may comprise a water bath at a temperature between 65 to 212° F.

### BRIEF DESCRIPTION OF THE DRAWINGS

FIG. 1 is a flowchart illustrating a method in accordance with the present invention.

FIG. 2 is a more detailed flowchart illustrating the method in accordance with the present invention.

FIG. 3 is a schematic diagram of an apparatus for performing the method in accordance with the invention.

### DETAILED DESCRIPTION OF PREFERRED EMBODIMENTS

The present invention will now be described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The purpose of the method is to provide a thin layer of aluminum over a copper conductor that can have many uses. For example, the aluminum clad copper can be anodized to provide an electrical insulator over the conductor. The wire can be used as the coil winding on electric motors. The anodized coating acts as an electrical insulator and may replace the organic enamels used today. For example, aluminum clad copper anodized wire may be used as a replacement for the existing copper windings in automotive starter motors and alternators. Additionally this wire may be a successful replacement for any 500 watt or smaller motor application, for example.

The method is directed to cladding one or more aluminum strips around a core of oxygen free copper resulting in a solid phase bonded composite, or aluminum clad copper wire. For example, the copper core could be a rod or wire and the composite may be a composite electrical conductor or wire. The copper rod or wire may have a diameter of about 0.2294 (3 AWG gauge) to ⅜ inches (0.375 inches), for example. In addition, the aluminum layer could be relatively thin, such as, for example, between about 0.003 to 0.030 inches.

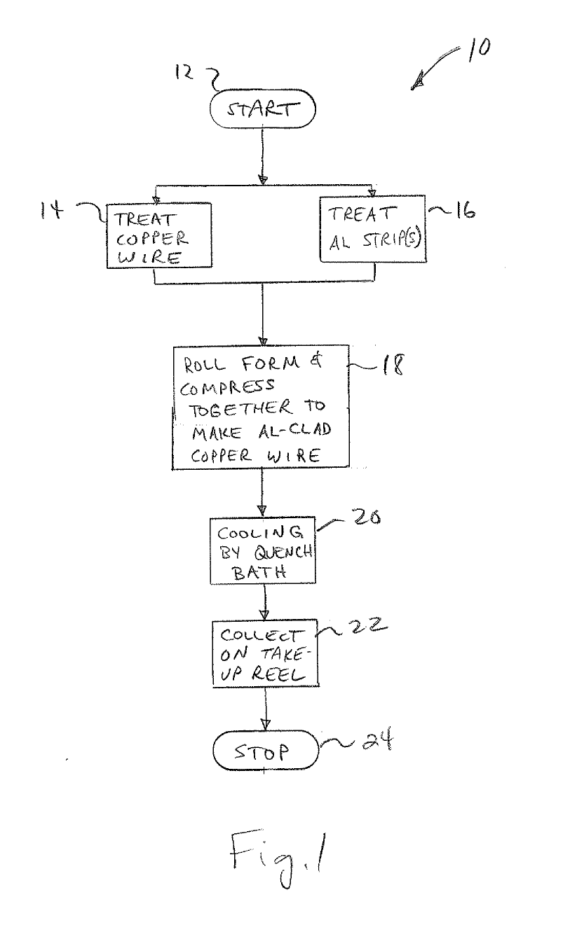

Referring now initially to the flowchart 10 of FIG. 1, the method is now described. The method is for making an aluminum clad copper wire from a copper wire and at least one aluminum strip solid phase bonded together. After the start (Block 12), the method illustratively includes at Block 14 treating a surface of the copper wire, such as by heating the copper wire during exposure to an oxidizing ambient followed by a reducing ambient as the copper wire is advanced along a first input path as described in further detail below. The method also includes treating a surface of the at least one aluminum strip at Block 16, such as by heating during exposure to an oxidizing ambient followed by a reducing ambient as the at least one second aluminum strip is advanced along at least one second input path. At Block 18 the method includes roll forming and compressing together the treated surface of the copper wire and the treated surface of the at least one aluminum strip to make the aluminum clad copper wire.

At Block 20 the method further includes cooling the aluminum clad copper wire by passage through at least one quenching media bath as the aluminum clad copper wire is advanced along an output path. The aluminum clad copper wire may collected on a take-up reel at Block 22 before stopping at Block 24. Of courser those of skill in the art will appreciate that other steps may also be included, such as testing, and anodizing the outer aluminum layer in some embodiments.

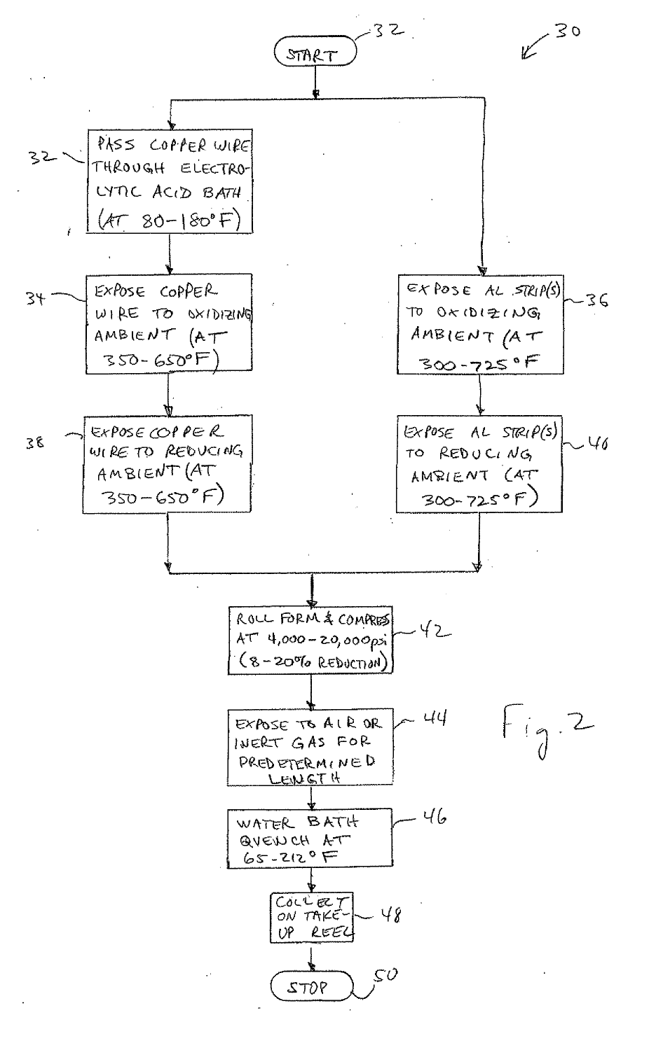

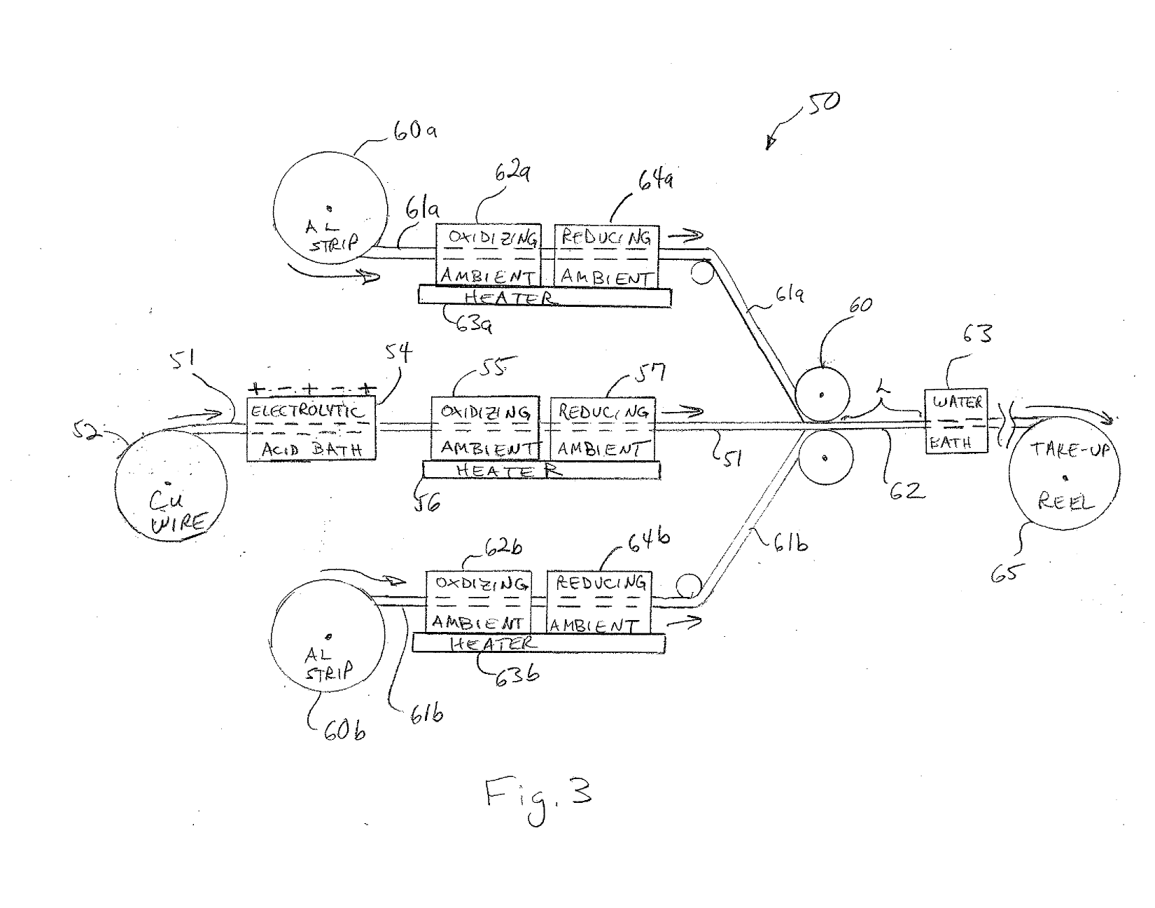

Referring now additionally to the flowchart 30 of FIG. 2 and the schematically illustrated apparatus 50 of FIG. 3, additional embodiments and details are now described. In particular, after the start (Block 32) the copper wire 51 is payed out from a supply reel 52 and is illustratively passed through an electrolytic acid bath 54 (Block 32). The electrolytic acid bath 54 illustratively has cells with alternating polarity, but preferably ending and starting with the same polarity—in the illustrated embodiment both starting and ending with positive (+) cells, although the reverse is also possible. The acid solution may comprise about 5% to 30% sulfuric (H₂SO₄) acid by weight and water and may be operated at a temperature of about 80° F. to 190° F. to affect the desired initial cleaning action. Other formulations and parameters may also be used.

Both the aluminum strips 61a, 61b and the oxygen free copper wire 51 may be heated to specific temperatures and a surface cleaning treatment may be continuously applied prior to forming the aluminum around the copper wire. More particularly, the copper wire is exposed to an oxidizing ambient (Block 34), such as while being heated to a temperature between about 350° F. to 650° F. within the oxidizing ambient chamber 55 and associated heater 56 arrangement of the schematically illustrated apparatus 50. Of course, in some embodiments the oxidizing ambient may be air so that a separate oxidizing ambient chamber 55 is not needed.

The aluminum strips 61a, 61b are payed off of respective supply reels 60a, 60b and advanced into similar respective oxidizing ambient chambers 62a, 62b at Block 36. The respective heaters 63a, 63b may maintain a temperature of the aluminum strips 61a, 61b between about 300° F. to 725° F.

As will be appreciated by those skilled in the art, the surface treatment/cleaning of both aluminum and copper may be accomplished by heating the metals in air to the temperatures mentioned above, thus creating a thin light oxide film on each metalls surface which may then be immediately exposed to a reducing ambient, such as an ambient containing from 2% to 100% hydrogen and/or mixed with nitrogen or other inert gases in the respective reducing ambient chambers 64a, 64b, 57 (Blocks 38, 40). This results in the direct reduction of the oxide to a pure and clean metal surface ready for bonding.

At Block 42 solid phase bonding is illustratively accomplished when the cleaned metal components 61a, 61b, 51 are roll formed and compressed together at the rolling mill 60 including an arrangement of rollers as will be appreciated by those skilled in the art. The rolling mill 60 may

apply pressures of 4000 psi to 20,000 psi using a reduction in cross-sectional area having about a minimum of 8.0% to a maximum of 20.0%, for example, while maintaining the temperatures of the metals as described above.

The composite structure or aluminum clad copper wire 62 illustratively continues and exits the rolling mill 60 into a short open space having a predetermined length L between 1 in. to 24 in., for example, that may be covered with either air or inert gases. At Block 46 the aluminum clad copper wire 62 is cooled by passage through a water bath 63 having a temperature between about 65° to 212° F. Thereafter, the aluminum clad copper wire 63 may continue and enter one or more additional lower temperature quench media baths (not shown), each having a temperature lower than its proceeding bath. Thereafter, the aluminum clad copper wire 62 may be further processed, such as to form the desired thickness and characteristics of an oxide insulating layer before collection or winding onto a take-up reel 65 at Block 46, as will be appreciated by those skilled in the art. The process stops at Block 50.

As described herein, the copper wire 51 is advanced along a first input path to the rolling mill 60, as the aluminum strips 61a, 61b are advanced along respective second input paths until convergence with the first input path at the rolling mill 60. Downstream from the rolling mill 60 the aluminum clad copper wire is advanced along an output path of travel as will be appreciated by those skilled in the art. Accordingly, the processes for making the aluminum clad copper wire may be advantageously carried out in a continuous fashion. In other embodiments, some of the steps may be performed in a batch operation as will be appreciated by those skilled in the art.

Although two aluminum strips 61, 61b have been shown and described, as few as one and more than two such strips may be solid phase bonded to the copper wire. Accordingly, many modifications and other embodiments of the invention will come to the mind of one skilled in the art having the benefit of the teachings presented in the foregoing description. Therefore, it is to be understood that the invention is not to be limited to the specific embodiments disclosed, and that modifications and embodiments are intended to be included.

That which is claimed is:

1. A method for making an aluminum clad copper wire from a copper wire and at least one aluminum strip solid phase bonded together, the method comprising:
treating a surface of the copper wire by heating the copper wire during exposure to an oxidizing ambient followed by a reducing ambient as the copper wire is advanced along a first input path;
treating a surface of the at least one aluminum strip by heating during exposure to an oxidizing ambient followed by a reducing ambient as the at least one second aluminum strip is advanced along at least one second input path;
roll forming and compressing together the treated surface of the copper wire and the treated surface of the at least one aluminum strip at a convergence between the first and at least one second input paths to make the aluminum clad copper wire and as the aluminum clad copper wire is advanced along an output path to thereby solid phase bond together the copper wire and the at least one aluminum strip; and
cooling the aluminum clad copper wire by passage through at least one quenching media bath as the aluminum clad copper wire is advanced along the output path.

2. A method according to claim 1 wherein roll forming and compressing together the treated surface of the copper wire and the treated surface of the at least one aluminum strip comprises applying a pressure in a range of about 4,000 to 20,000 psi.

3. A method according to claim 2 wherein roll forming and compressing together the treated surface of the copper wire and the treated surface of the at least one aluminum strip further comprises reducing a cross-sectional area of the aluminum clad copper wire from 8 to 20 percent.

4. A method according to claim 1 further comprising passing the copper wire through an electrolytic acid bath as the copper wire is advanced along the first input path.

5. A method according to claim 4 wherein the electrolytic acid bath comprises cells of alternating polarity and wherein a first cell has a same polarity as a last cell.

6. A method according to claim 4 wherein the electrolytic acid bath is at a temperature in a range of about 80 to 180° F. and comprises an aqueous solution of about 5 to 30 percent by weight of sulfuric acid.

7. A method according to claim 1 wherein heating the copper wire comprises heating the copper wire to a temperature in a range of 350 to 650° F.

8. A method according to claim 1 wherein heating the at least one aluminum strip comprises heating the at least one aluminum strip to a temperature in a range of 300 to 725° F.

9. A method according to claim 1 wherein the copper wire comprises an oxygen free copper wire having a circular cross section and a diameter in a range of 0.2 to 0.4 inches.

10. A method according to claim 1 wherein the at least one aluminum strip has a thickness in a range of 0.003 to 0.030 inches.

11. A method according to claim 1 wherein exposing the copper wire to an oxidizing ambient comprises exposing the copper wire to air.

12. A method according to claim 1 wherein exposing the at least one aluminum strip to an oxidizing ambient comprises exposing the at least one aluminum strip to air.

13. A method according to claim 1 wherein exposing the copper wire to a reducing ambient comprises exposing the copper wire to 2 to 100 percent by weight of hydrogen in an inert gas.

14. A method according to claim 1 wherein exposing the at least one aluminum strip to a reducing ambient comprises exposing the at least one aluminum strip to 2 to 100 percent by weight of hydrogen in an inert gas.

15. A method according to claim 1 further comprising exposing the aluminum clad copper wire to air or inert gas for a predetermined length of the output path prior to the at least one quenching media bath.

16. A method according to claim 1 wherein the at least one quenching media bath comprise a water bath at a temperature between 65 to 212° F.

17. A method for making an aluminum clad copper wire from a copper wire and at least one aluminum strip solid phase bonded together, the method comprising:
treating a surface of the copper wire by heating the copper wire to a temperature in a range of 350 to 650° F. during exposure to an oxidizing ambient followed by a reducing ambient as the copper wire is advanced along a first input path;
treating a surface of the at least one aluminum strip by heating to a temperature in a range of 300 to 725° F. during exposure to an oxidizing ambient followed by a reducing ambient as the at least one second aluminum strip is advanced along at least one second input path;
roll forming and compressing together the treated surface of the copper wire and the treated surface of the at least one aluminum strip at a convergence between the first and at least one second input paths so as to make the aluminum clad copper wire to have reduced cross-sectional area of from 8 to 20 percent and as the aluminum clad copper wire is advanced along an output path to thereby solid phase bond together the copper wire and the at least one aluminum strip; and
cooling the aluminum clad copper wire by passage through at least one quenching media bath as the aluminum clad copper wire is advanced along the output path.

18. A method according to claim 17 wherein roll forming and compressing together the treated surface of the copper wire and the treated surface of the at least one aluminum strip comprises applying a pressure in a range of about 4,000 to 20,000 psi.

19. A method according to claim 17 further comprising passing the copper wire through an electrolytic acid bath as the copper wire is advanced along the first input path.

20. A method according to claim 17 wherein the copper wire comprises an oxygen free copper wire having a circular cross section and a diameter in a range of 0.2 to 0.4 inches; and wherein the at least one aluminum strip has a thickness in a range of 0.003 to 0.030 inches.

21. A method according to claim 17 wherein exposing the copper wire to an oxidizing ambient comprises exposing the copper wire to air; and wherein exposing the at least one aluminum strip to an oxidizing ambient comprises exposing the at least one aluminum strip to air.

22. A method according to claim 17 wherein exposing the copper wire to a reducing ambient comprises exposing the copper wire to 2 to 100 percent by weight of hydrogen in an inert gas; and wherein exposing the at least one aluminum strip to a reducing ambient comprises exposing the at least one aluminum strip to 2 to 100 percent by weight of hydrogen in an inert gas.

23. A method for making an aluminum clad copper wire from a copper wire and at least one aluminum strip solid phase bonded together, the method comprising:
passing the copper wire through an electrolytic acid bath at a temperature in a range of about 80 to 180° F. and comprising an aqueous solution of about 5 to 30 percent by weight of sulfuric acid as the copper wire is advanced along a first input path;
treating a surface of the copper wire downstream from the electrolytic acid bath by heating the copper wire during exposure to an oxidizing ambient followed by a reducing ambient as the copper wire is advanced along the first input path;
treating a surface of the at least one aluminum strip by heating during exposure to an oxidizing ambient followed by a reducing ambient as the at least one second aluminum strip is advanced along at least one second input path;
roll forming and compressing together the treated surface of the copper wire and the treated surface of the at least one aluminum strip at a convergence between the first and at least one second input paths to make the aluminum clad copper wire and as the aluminum clad copper wire is advanced along an output path to thereby solid phase bond together the copper wire and the at least one aluminum strip; and
cooling the aluminum clad copper wire by passage through at least one quenching media bath as the aluminum clad copper wire is advanced along the output path.

24. A method according to claim 23 wherein the electrolytic acid bath comprises comprises cells of alternating polarity and wherein a first cell has a same polarity as a last cell.

25. A method according to claim 23 wherein roll forming and compressing together the treated surface of the copper wire and the treated surface of the at least one aluminum strip comprises applying a pressure in a range of about 4,000 to 20,000 psi.

26. A method according to claim 25 wherein roll forming and compressing together the treated surface of the copper wire and the treated surface of the at least one aluminum strip further comprises reducing a cross-sectional area of the aluminum clad copper wire from 8 to 20 percent.

27. A method according to claim 23 wherein heating the copper wire comprises heating the copper wire to a temperature in a range of 350 to 650° F.; and wherein heating the at least one aluminum strip comprises heating the at least one aluminum strip to a temperature in a range of 300 to 725° F.

28. A method according to claim 23 wherein the copper wire comprises an oxygen free copper wire having a circular cross section and a diameter in a range of 0.2 to 0.4 inches; and wherein the at least one aluminum strip has a thickness in a range of 0.003 to 0.030 inches.

29. A method according to claim 23 wherein the copper wire comprises an oxygen free copper wire having a circular cross section and a diameter in a range of 0.2 to 0.4 inches; and wherein the at least one aluminum strip has a thickness in a range of 0.003 to 0.030 inches.

30. A method according to claim 23 wherein exposing the copper wire to an oxidizing ambient comprises exposing the copper wire to air; and wherein exposing the at least one aluminum strip to an oxidizing ambient comprises exposing the at least one aluminum strip to air.

31. A method according to claim 23 wherein exposing the copper wire to a reducing ambient comprises exposing the copper wire to 2 to 100 percent by weight of hydrogen in an inert gas; and wherein exposing the at least one aluminum strip to a reducing ambient comprises exposing the at least one aluminum strip to 2 to 100 percent by weight of hydrogen in an inert gas.
